(19) United States
(12) Patent Application Publication
(10) Pub. No.: US 2024/0004992 A1
(43) Pub. Date: Jan. 4, 2024

(54) RESOURCE PROTECTION

(71) Applicant: Infineon Technologies AG, Neubiberg (DE)

(72) Inventors: Patrik Eder, Taufkirchen (DE); Rainer Wolfgang Kaiser, München (DE)

(21) Appl. No.: 18/345,008

(22) Filed: Jun. 30, 2023

(30) Foreign Application Priority Data
Jul. 1, 2022 (DE) 10 2022 206 744.4

(51) Int. Cl. G06F 21/54; G06F 21/55

(52) U.S. Cl. CPC G06F 21/54; G06F 21/554

(57) ABSTRACT

In an embodiment an integrated circuit comprises a plurality of ports. Of a plurality of gating circuits, each gating circuit blocks or grants access to at least one of the ports depending on a release signal. From a plurality of configuration registers, each configuration register for stores the information to which group a gating circuit of the plurality of gating circuits belongs. A tag evaluation circuit receives an identifier from an access request from a component and outputs a group identifier for the access. There is a plurality of comparison circuits. Each comparison circuit compares the group identifier with the content of one of the configuration registers and outputs the release signal to a gating circuit of the plurality of gating circuits.

### REFERENCE TO RELATED APPLICATIONS

This application claims priority to German Patent Application 10 2022 206 744.4, filed on Jul. 1, 2022. The contents of the above-referenced patent application is hereby incorporated by reference in its entirety.

### FIELD OF THE INVENTION

The present disclosure relates to the protection of resources in electronic circuits. In modern integrated circuits, a plurality of sources may access a common resource like an input/output (IO) port. Not all sources are allowed to access specific ports to ensure that safety and security of functions of the integrated circuit (IC) are not impacted. The protected asset may be the function running on the IC and unwanted side effects caused by its usage are prevented—i.e. the protection prevents a malicious or unintended false usage of the resource. To protect the access, the source of an access request is determined by comparing identifiers (“tags”) of transfer initiators with a black or white list of identifiers, which indicate forbidden respectively allowed accesses. If a source is “whitelisted” access will be granted; if “blacklisted”, the access will not succeed, be ignored or an event, such as security/safety alarm or software interrupt, will be raised.

### BACKGROUND OF THE INVENTION

The access rights may be altered during the runtime of the integrated circuit: A module may comprise one or a plurality of processors cores. At start of the runtime of the integrated circuit, a unit System Startup Control (SSC) has all rights and control over the module and will configure the general availability of the module and lock central settings for the next stage. E.g., it will disable functions that are not available due to package limitations.

In the next step, a supervising software, which may be an operating system boot software or an overall supervisor module, sets the configuration based on environmental parameters. These parameters may e.g. depend on if an electric or a gasoline engine will be controlled. The resources are now mapped to a specific SW module, which may not alter the access configuration, but change the function of a pin, such as its communication direction, output level or drive strength.

Once the supervising software has locked the configuration, the device is in a user mode in which the modules use their assigned resources.

The access protection comes into action as soon as a request, malicious or due to an SW issue, tries to access a resource (other port or an configuration register area). Then, the access protection mechanism will prevent the access and, based on its configuration, either report the access to a supervising unit (“SMU”) or simply ignore the access.

Each of these steps may need a different level of protection on every resource. Additionally, the large variety of possible tagging mechanisms such as physical machine identification number (ID) or virtual and software defined IDs puts a burden on the systems to spend a lot of HW to implement such a feature.

In an embodiment, an integrated circuit comprises a plurality of ports. Of a plurality of gating circuits, each gating circuit blocks or grants access to at least one of the ports depending on a release signal. From a plurality of configuration registers, each configuration register stores the information to which group a gating circuit of the plurality of gating circuits belongs.

A tag evaluation circuit receives an identifier together with an access request from a component and outputs a group identifier for the access. There is a plurality of comparison circuits. Each comparison circuit compares the group identifier with the content of one of the configuration registers and outputs the release signal to a gating circuit of the plurality of gating circuits.

### SUMMARY OF THE INVENTION

Those skilled in the art will recognize additional features and advantages upon reading the following detailed description, and upon viewing the accompanying drawings.

The present invention/disclosure is illustrated by way of example, and not by way of limitation, in the figures of the accompanying drawings in which like reference numerals refer to similar or identical elements. The elements of the drawings are not necessarily to scale relative to each other. The features of the various illustrated embodiments/aspects/examples can be combined unless they exclude each other.

### BRIEF DESCRIPTION OF THE DRAWINGS

FIG. 1 illustrates a first embodiment of a circuit for granting or blocking access to ports;

FIG. 2 illustrates a second embodiment of a circuit for granting or blocking access to ports;

FIG. 3 illustrates details of a tag identification circuit of one of the first or second embodiments.

### DETAILED DESCRIPTION

The embodiments described herein provide an apparatus and a method for giving access to ports of an integrated circuit.

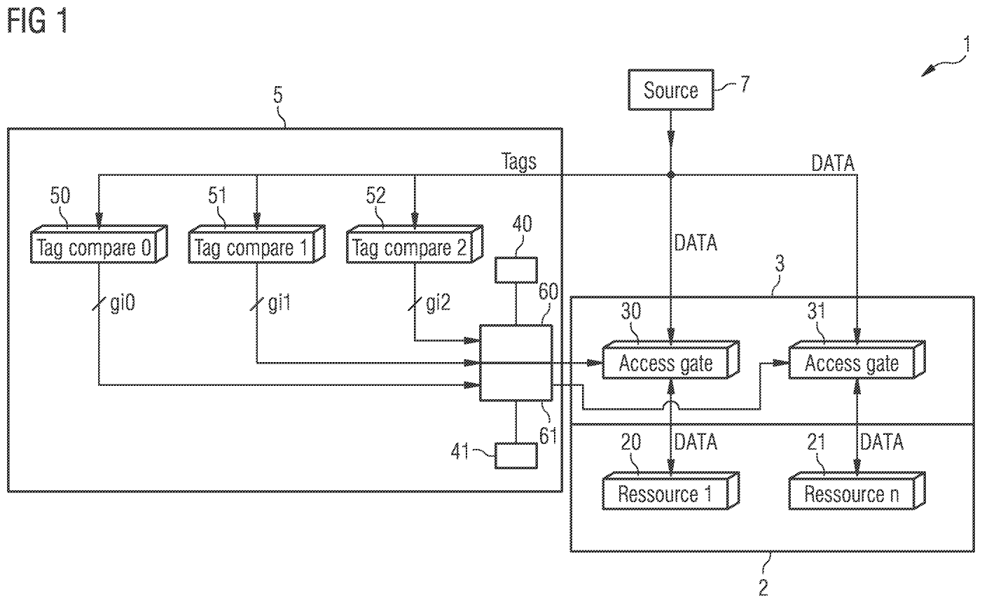

FIG. 1 shows an embodiment of an integrated circuit which comprises, inter alia, resources 2, in form of ports 20 and 21, a plurality 3 of gating circuits 30 and 31, source 7 for providing data and tags and an evaluation unit 5. The evaluation unit 5 comprises tag evaluation circuits 50, 51 and 52, configuration registers 40 and 41 and comparison circuits 60 and 61.

An access request from the source 7 is received with data, a tag identifier identifying the requesting unit and the access type like read or write. A tag identifier is specific to a specific requesting unit, e.g. to a specific CPU (Central Processing Unit) or a specific virtual machine (VM). There are access restrictions defining which requesting unit has permission to access specific ports. The underlying access rights may be grouped according to the involved ports, e.g. defining that a specific virtual machine has rights to access a group of ports. A tag evaluation circuit 50 may determine, from the tag identifier (tag ID) of the requesting unit, to which group of ports the source has access. The tag evaluation circuit 50 outputs a group identifier gi0 which indicates a group of ports. The group size may be e.g. two, four or eight, depending on the application.

A second tag evaluation circuit 51 and third tag evaluation circuit 52 simultaneously evaluate the tag identifier and output the group identifiers gi1 and gi2 if a match is found. In this embodiment, the tag evaluation circuit 50 determines if the tag identifier belongs to a virtual machine or CPU that has access to a first group, the second tag evaluation circuit 51 determines if the tag identifier belongs to a virtual machine or CPU that has access to a second group, and the third tag evaluation circuit 52 determines if the tag identifier belongs to a virtual machine or CPU that has access to a third group. If the first tag evaluation circuit 50 has found a match, that means the tag identifier shows that the sending CPU has access to the first group, the output gi0 is set to one. If no match is found, the output gi0 will output 0. In the same way, the tag evaluation circuits 51 and 52 check if the tag identifier indicates a permitted access to the second group and the third group, respectively.

The comparison circuits 60 and 61 receive the signals gi0, gi1 and gi2 and compare them to the output signals of the configuration circuits 40 and 41. The comparison circuit 60 controls the gating circuit 30 to either grant or block access of the data provided by the source 7 to the port 20. In the same way, the comparison circuit 61 controls the gating circuit 31 to either grant or block access of the data provided by the source 7 to the port 21. In case of a write command by the integrated circuit, the data from the source will be driven to the port 21 and be accordingly output to the exterior of the chip.

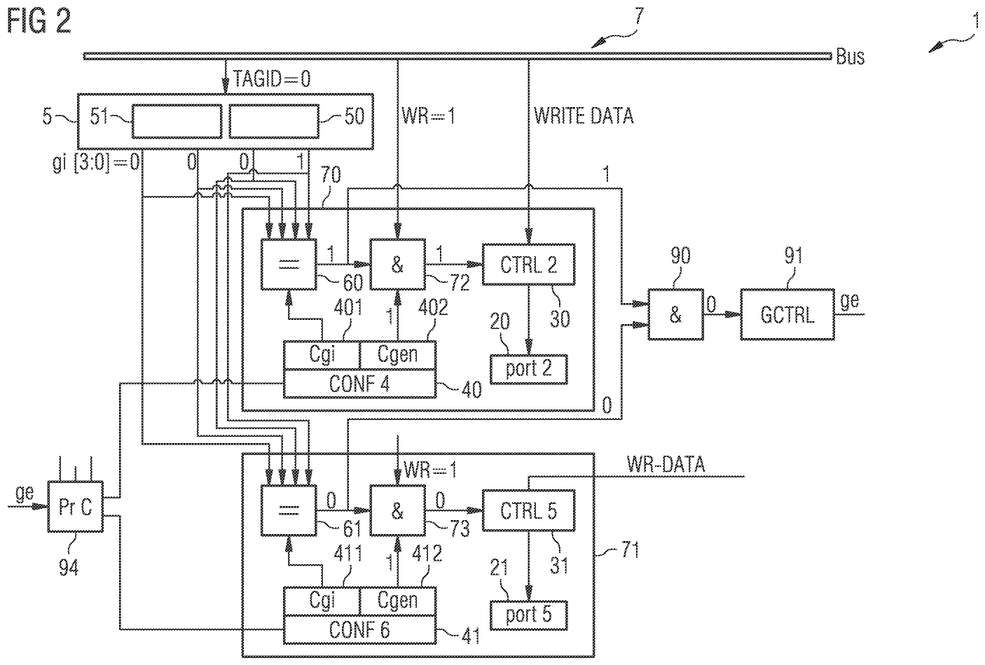

FIG. 2 illustrates a second embodiment of a circuit for granting or blocking access to ports. The source 7 is illustrated as a bus to which CPUs and virtual machines may read or write, e.g. to use the bus to transfer data that shall be output at the ports. The access request may contain data to be output and a tag identifier identifying the requesting CPU respectively virtual machine. The tag identifier is processed by the tag evaluation circuits 50 and 51 which will output a group identifier at the nodes gi[3:0] if one or more tag evaluation circuits finds a match.

It should be noted that several group identifiers may be simultaneously output because the CPU's respective virtual machines may have access to a plurality of groups of ports.

An access point 70 comprises the comparator 60, the configuration register 40, an AND gate 72 and a gating circuit 30. The configuration register comprises two sets of registers, one set 401 for the group identifier and one set 402 for a general configuration. In the general configuration, the information if an access is currently allowed may be stored. During booting of the integrated circuit 1, the ports may be disabled, which can be stored in the set 402 of general configuration registers. The set 401 of group identifier configuration registers can store the information to which group respectively which groups the port 2 belongs. In this example, port 2 belongs to the first group, whereas the port 5, which will be further described below, belongs to group 2.

In this example, the group identifiers gi[0:3] equal 0001 and thereby indicate that the tag identifier of the access shows a permitted access to group 1 of ports. The compare unit 60 compares the value gi[0:3] with the content of the set 401 of group identifier configuration registers. As there is a match, the comparator 60 outputs a one. This one is received by the AND gate 72 that also receives a one from the set 402 of general configuration registers, indicating a general enablement of the port, and a one from the bus, indicating a write command from the bus. The AND gate 72 outputs a one, as a release signal, to enable to the CTRL2 register to be written, which in turn will write its content to port 2.

An access point 71 comprises the comparator 61, the configuration register 41, an AND gate 73 and a gating circuit 31. The configuration register 41 comprises two sets of registers, one set 411 for the group identifier and one set 412 for a general configuration. In the general configuration, the information if an access is currently allowed may be stored. During booting of the integrated circuit 1, the ports may be disabled, which can be stored in the set 412 of general configuration registers. The set 411 of group identifier configuration registers may store the information to which group respectively which groups the port 5 belongs, in this example to group 2.

The group identifiers gi[3:0] do not indicate that the tag identifier of the access shows a permitted access to group 2 of ports. The compare unit 61 compares the value gi[3:0] with the content of the set 411 of group identifier configuration registers. As there is no match, the comparator 61 outputs a zero. This zero is received by the AND gate 73, which also receives a one from the set 412 for a general configuration, indicating a general enablement of the port, and a one from the bus, indicating a write command from the bus. The AND gate 73 outputs a zero to disable to the CTRL5 register which will not be written. The content of port 5 stays unchanged.

If each pin of a typical microcontroller gets a complete access protection, the number of bits needed to configure the access protection would be 27.6k Bit (92 Bit/protection group*300 Pins). If the grouping approach is used, whereby, as an example, one group may comprise four pins, only 6.9k bits are needed. The term pin is synonymously used with port.

By clustering the access protection, the overall verification complexity is also reduced. As an example, if a new tag has to be supported, only the tag evaluation circuit 50 has to be verified because the match mechanism abstracts the number of supported tags away from the resources.

Another benefit is that a centralized access tag configuration reduces the risk of misconfiguration, i.e. by missing to update an resource. If an access protection scheme needs to be updated concerning the whole set of resources, only the shared access tag evaluation needs to be updated and not the configuration resource by resource.

This centralized scheme also removes the risk of race conditions which may be caused by delays during the update of the configuration, which may lead to a part of to be protected resources being still in the outdated configuration while the other part is already at the correct setting.

Referring to FIG. 2, the outputs of the compare circuits 60 are also output to the AND gate 90 which, accordingly, outputs a zero to the global control circuit 91. The global control circuit 91 is disabled. If the AND, under different circumstances, outputs a one, the global control circuit 91 may configure all configuration registers 40, 41 at once. By this, not only single, but multiple or all resources may be protected by the scheme. In case of device pins, there are multiple methods to update the pin, one is to update a whole group of pins at once. As the source must “own” all of the ressources/pins to update the whole group, an additional layer of protection is needed. In other words, it needs just one resource having no access to a specific source to also gate access to the others sources. This may be implemented by combining the sub-allowances to an overall allowance for the entire group of resources. As the information per resource has already been generated, the additional group information can be implemented by a mere AND-function of the separate allow/block signals. With this scheme, a plurality of groups can concurrently be configured. That means that several groups are configured at the same time.

In the embodiment of FIG. 2, a programming circuit 94 is used to configure the configuration registers 40 and 41. Typically, the configuration registers 40 and 41 are updated at booting of the integrated system. It is possible to update a plurality of configuration registers simultaneously if the output of the global control 91 outputs a 1 as signal ge.

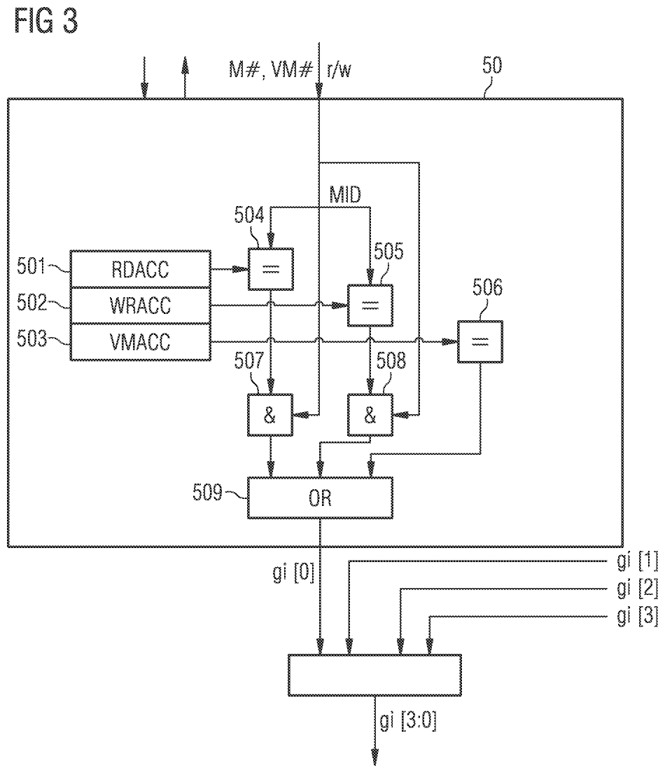

FIG. 3 shows an embodiment of a tag evaluation circuit 50. It receives the identification tag M for the CPU, the identification tag for the virtual machine VM and a flag that indicates if there is a read or a write. There are three registers, RDACC 501 for storing, which CPUs have read access, WDACC 502 for storing, which CPU has write access, and VMACC 503 for storing, which virtual machine has access. The outputs of these three registers are driven to a comparator 504, 505 and 506, respectively, each of which compares its stored whitelisted tags with the identifiers active transaction tag fed into the tag evaluation circuit 50. In case of a match, the comparator outputs a one. If there is a read command, indicated by the signal RD to be one, the OR 507 gate outputs a 1 at gi[0], which symbolizes that there is a permitted access from a CPU or a virtual machine. Analogously, if there is a write command, indicated by the signal WD to be one, the OR 509 gate outputs a 1 at gi[0], which symbolizes that there is a permitted access from a CPU or a virtual machine.

Although specific embodiments/examples/aspects have been illustrated and described herein, it will be appreciated by those of ordinary skill in the art that a variety of alternate and/or equivalent implementations may be substituted for the specific embodiments/examples/aspects shown and described without departing from the scope of the present invention. This application is intended to cover any adaptations or variations of the specific embodiments/examples/aspects discussed herein. Therefore, it is intended that this invention be limited only by the claims and the equivalents thereof.

It should be noted that the methods and apparatus including its preferred embodiments as outlined in the present document may be used stand-alone or in combination with the other methods and apparatus disclosed in this document. In addition, the features outlined in the context of an apparatus are also applicable to a corresponding method, and vice versa. Furthermore, all aspects of the methods and systems/apparatus/devices/ . . . outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed:

1. An integrated circuit, comprising:
a plurality of ports;
a plurality of gating circuits, each gating circuit configured to block or grant access to at least one of the ports depending on a release signal;
a plurality of configuration registers, each configuration register configured to store information specifying which group a gating circuit of the plurality of gating circuits belongs;
a tag evaluation circuit configured to receive an identifier from an access request from a component and configured to output a group identifier for the access request; and
a plurality of comparison circuits, each comparison circuit configured to compare the group identifier with content of one of the configuration registers and configured to output the release signal to the gating circuit of the plurality of gating circuits.

2. The integrated circuit according to claim 1, whereby the gating circuit is further configured to receive an enable signal that indicates when either a read or write signal from or to a port is requested or not requested.

3. The integrated circuit according to claim 1, further comprising a programming circuit for the configuration registers, the programming circuit configured to change the content of the configuration registers.

4. The integrated circuit according to claim 3, whereby the programming circuit is configured to change a group of configuration registers, when the programming circuit receives enable signals from all comparison circuits that are assigned to the group of configuration registers.

5. The integrated circuit according to claim 1, whereby a size of a group of gating circuits is 2, 4 or 8.

6. The integrated circuit according to claim 1, further comprising a plurality of tag evaluation circuits.

7. The integrated circuit according to claim 6, whereby a plurality of central processing units (CPUs) and/or virtual machines require accesses to one or more of the plurality of ports.

8. The integrated circuit according to claim 1, whereby a plurality of groups of configuration registers can be configured concurrently.

9. An integrated circuit, comprising:
a plurality of ports;
a plurality of gating circuits coupled to the plurality of ports, respectively;
a data and tag source circuit coupled to each of the plurality of gating circuits, such that the plurality of gating circuits, respectively, are arranged between the data and tag source circuit and the plurality of ports, respectively;
a plurality of tag evaluation circuits having a plurality of tag evaluation inputs, respectively, and having a plurality of tag evaluation outputs, respectively, the plurality of tag evaluation inputs coupled to the data and tag source circuit; and
a first comparison circuit having first and second comparison inputs and a comparison output, the first comparison input of the first comparison circuit coupled and an output of a first tag evaluation circuit of the plurality of tag evaluation circuits, the second comparison input of the first comparison circuit coupled to a first configuration register, and the comparison output of the first comparison circuit coupled to a first gating circuit of the plurality of gating circuits.

10. The integrated circuit of claim 9, further comprising:
a second comparison circuit having a first comparison input, a second comparison input, and a comparison output, the first comparison input of the second comparison circuit coupled to an output of a second tag evaluation circuit of the plurality of tag evaluation circuits, the second comparison input of the second comparison circuit coupled to a second configuration register, and the comparison output of the second comparison circuit coupled to a second gating circuit of the plurality of gating circuits.

11. The integrated circuit of claim 10, wherein the first gating circuit is configured to pass data from the data and tag source circuit to a first port of the plurality of ports when the first tag evaluation circuit determines that a tag ID provided by the data and tag source circuit corresponds to the first port.

12. The integrated circuit of claim 11, wherein the first gating circuit is configured to block data from the data and tag source circuit to the first port when the tag ID provided by the data and tag source circuit corresponds to a second port of the plurality of ports that differs from the first port.

13. The integrated circuit of claim 12, wherein the second gating circuit is configured to pass the data from the data and tag source circuit to the second port when the second tag evaluation circuit determines that the tag ID provided by the data and tag source circuit corresponds to the second port.

14. The integrated circuit of claim 13, wherein the second gating circuit is configured to block the data from the data and tag source circuit to the second port when the tag ID provided by the data and tag source circuit corresponds to the first port.

15. The integrated circuit according to claim 10, further comprising a programming circuit for the first configuration register and the second configuration register, the programming circuit configured to change content of the first configuration register and the second configuration register.

16. The integrated circuit according to claim 10, wherein the plurality of tag evaluation circuits concurrently evaluate a tag identifier provided by the data and tag source circuit, and output a plurality of group identifiers to the first and second comparison circuits.

17. The integrated circuit according to claim 10, wherein a tag evaluation circuit is configured to receive an identifier from an access request from a component and output a group identifier for the access request; wherein the first comparison circuit and the second comparison circuit are configured to compare the group identifier with content of the first configuration register and the second configuration register, respectively, and output release signals to the plurality of gating circuits to block or grant access to at least one of the ports depending on the release signals.

18. The integrated circuit according to claim 17, whereby a plurality of central processing units (CPUs) and/or virtual machines access to one or more of the plurality of ports.
